(19) United States
(12) Patent Application Publication
(10) Pub. No.: US 2006/0019149 A1
(43) Pub. Date: Jan. 26, 2006

(54) Soil battery

(76) Inventor: Peter H. Mahowald, Los Altos, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/896,254

(22) Filed: Jul. 21, 2004

(51) Int. Cl. H01M 14/00

(52) U.S. Cl. 429/47; 429/61; 429/62; 429/50

(57) ABSTRACT

Power for a device is generated by a soil battery. The soil battery includes anode material and cathode material placed in soil.

### BACKGROUND

There is an increasing recognition of the usefulness of sensors to monitor the condition of property and the operation of appliances. Typically, power outlets or batteries are used to provide power for sensors. In some instances, where sunlight is available, solar power may be also utilized.

However, each of the above listed sources of power has limitations. For example, for some sensors, no direct pathway to sunlight is available. The wiring required to connect a sensor to a power outlet may be expensive to install. Batteries often discharge after a period of time and need to be replaced. This can present a difficulty when the sensor is not readily accessible. Even when the sensor is accessible, it is often difficult to detect when a battery is discharged. The necessary monitoring of the condition of the battery can be inconvenient and therefore neglected.

It is desirable, therefore, to explore other potential power sources for sensors.

### SUMMARY OF THE INVENTION

In accordance with embodiments of the present invention, power for a device is generated by a soil battery. The soil battery includes anode material and cathode material placed in soil.

### BRIEF DESCRIPTION OF THE DRAWINGS

FIG. 1 is a simplified block diagram showing a monitoring system in communication with various sensors powered by soil batteries in accordance with embodiments of the present invention.

FIG. 2 is a simplified block diagram showing soil batteries used in various applications to supply power in accordance with embodiments of the present invention.

### DESCRIPTION OF THE EMBODIMENT

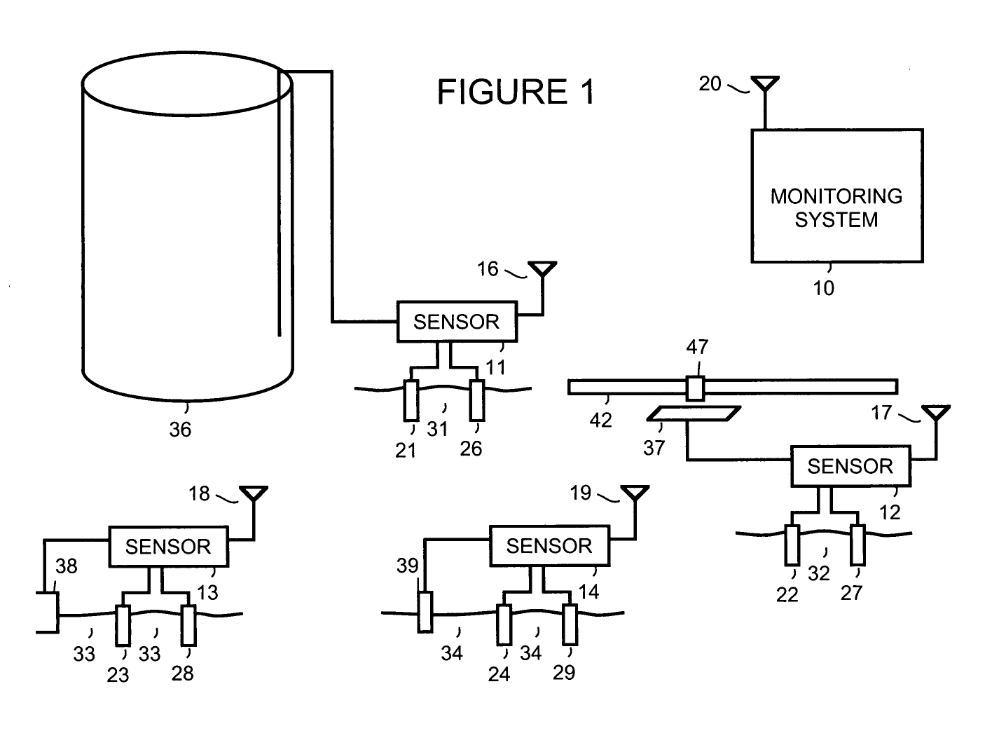

FIG. 1 is a simplified block diagram showing a monitoring system 10 in wireless communication with a sensor 11, a sensor 12, a sensor 13 and a sensor 14. For example, sensor 11 transmits wireless transmissions, via an antenna 16, that are received by an antenna 20 of monitoring system 10. Sensor 12 transmits wireless transmissions, via an antenna 17, that are received by antenna 20 of monitoring system 10. Sensor 13 transmits wireless transmissions, via an antenna 18, that are received by antenna 20 of monitoring system 10. Sensor 14 transmits wireless transmissions, via an antenna 19, that are received by antenna 20 of monitoring system 10.

Sensor 11 monitors the level of liquid remaining within a storage container 36. Sensor 11 is powered by a soil battery that includes an anode 21 and a cathode 26 placed in soil 31.

For example, anode 21 is a formed of zinc metal or some other material that functions as an anode. For example, cathode 26 is formed from copper or some other material that functions as a cathode. Electrolytes within soil 31 cause soil 31 to act as an electrical chemical system. Clay minerals function as anions. Plant nutrients such as magnesium, sodium, potassium, etc., function as cations. The chemical reactions at anode 21 and cathode 26 cause a small current to travel from anode 21 through cathode 26. Sensor 11 uses the resulting energy to perform low power monitoring and communication functions. Although the available minerals and nutrients near anode and cathode will tend to deplete, replacement electrolytes tend to diffuse in to replace the used minerals and nutrients. The soil battery tends to be most efficient in soils damp enough to allow efficient migration of electrolytes. The distance between anode 21 and cathode 26 is chosen to maximize current generation efficiency. This distance is typically around one to two feet, depending upon the soil. When anode 21 and/or cathode 26 corrode, they can be replaced. Soil amendments can be used to optimize properties of the soil.

Sensor 12 uses a moisture detector 37 to monitor integrity of a joint 37 within a pipe 42. For example, pipe 42 is a water pipe used in a home or business. Sensor 12 is powered by a soil battery that includes an anode 22 and a cathode 27 placed in soil 32.

For example, anode 22 is a formed of zinc metal or some other material that functions as an anode. For example, cathode 27 is formed from copper or some other material that functions as a cathode. Electrolytes within soil 32 cause soil 32 to act as an electrical chemical system. Clay minerals function as anions. Plant nutrients such as magnesium, sodium, potassium, etc., function as cations. The chemical reactions at anode 22 and cathode 27 cause a small current to travel from anode 22 through cathode 27. Sensor 12 uses the resulting energy to perform low power monitoring and communication functions. Although the available minerals and nutrients near anode and cathode will tend to deplete, replacement electrolytes tend to diffuse in to replace the used minerals and nutrients. The soil battery tends to be most efficient in soils damp enough to allow efficient migration of electrolytes. The distance between anode 22 and cathode 27 is chosen to maximize current generation efficiency. This distance is typically around one to two feet, depending upon the soil. When anode 22 and/or cathode 27 corrode, they can be replaced.

Sensor 13 uses a moisture detector 38 to monitor moisture within soil 33. Sensor 13 is powered by a soil battery that includes an anode 23 and a cathode 28 placed in soil 33.

For example, anode 23 is a formed of zinc metal or some other material that functions as an anode. For example, cathode 28 is formed from copper or some other material that functions as a cathode. Electrolytes within soil 33 cause soil 33 to act as an electrical chemical system. Clay minerals function as anions. Plant nutrients such as magnesium, sodium, potassium, etc., function as cations. The chemical reactions at anode 23 and cathode 28 cause a small current to travel from anode 23 through cathode 28. Sensor 13 uses the resulting energy to perform low power monitoring and communication functions. Although the available minerals and nutrients near anode and cathode will tend to deplete, replacement electrolytes tend to diffuse in to replace the used minerals and nutrients. The soil battery tends to be most efficient in soils damp enough to allow efficient migration of electrolytes. The distance between anode 23 and cathode 28 is chosen to maximize current generation efficiency. This distance is typically around one to two feet, depending upon the soil. When anode 23 and/or cathode 28 corrode, they can be replaced.

Sensor 14 uses a thermometer 39 to monitor temperature of soil 34. Sensor 14 is powered by a soil battery that includes an anode 24 and a cathode 29 placed in soil 34.

For example, anode 24 is a formed of zinc metal or some other material that functions as an anode. For example, cathode 29 is formed from copper or some other material that functions as a cathode. Electrolytes within soil 34 cause soil 34 to act as an electrical chemical system. Clay minerals function as anions. Plant nutrients such as magnesium, sodium, potassium, etc., function as cations. The chemical reactions at anode 24 and cathode 29 cause a small current to travel from anode 24 through cathode 29. Sensor 14 uses the resulting energy to perform low power monitoring and communication functions. Although the available minerals and nutrients near anode and cathode will tend to deplete, replacement electrolytes tend to diffuse in to replace the used minerals and nutrients. The soil battery tends to be most efficient in soils damp enough to allow efficient migration of electrolytes. The distance between anode 24 and cathode 29 is chosen to maximize current generation efficiency. This distance is typically around one to two feet, depending upon the soil. When anode 24 and/or cathode 29 corrode, they can be replaced.

In addition to powering sensors, soil batteries can be used with any device that does not require greater power or current than can be supplied by a soil battery.

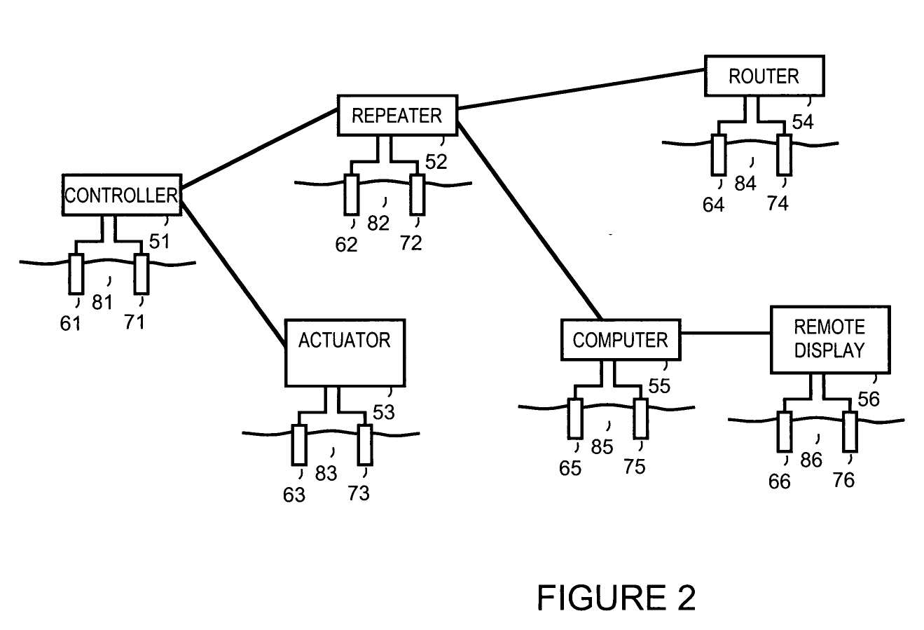

For example, FIG. 2 shows a controller 51 that is powered by a soil battery implemented by placing an anode 61 and a cathode 71 into soil 81. Controller 51 controls an actuator 53. Actuator 53 is powered by a soil battery implemented by placing an anode 63 and a cathode 73 into soil 83. For example, communication between controller 51 and actuator 53 is performed by a wire link, a wireless link or an optical link.

Controller 51 communicates with a repeater 52. Repeater 52 is powered by a soil battery implemented by placing an anode 62 and a cathode 72 into soil 82. For example, communication between controller 51 and repeater 52 is performed by a wire link, a wireless link or an optical link.

Repeater 52 communicates with a router 54. Router 54 is powered by a soil battery implemented by placing an anode 64 and a cathode 74 into soil 84. For example, communication between repeater 52 and router 54 is performed by a wire link, a wireless link or an optical link.

Repeater 52 communicates with a computer 55. Computer 55 is powered by a soil battery implemented by placing an anode 65 and a cathode 75 into soil 85. For example, communication between repeater 52 and computer 55 is performed by a wire link, a wireless link or an optical link.

Computer 55 controls a remote display 56. Remote display 56 is powered by a soil battery implemented by placing an anode 66 and a cathode 76 into soil 86. For example, communication between remote display 56 and computer 55 is performed by a wire link, a wireless link or an optical link.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

I claim:

1. A system comprising:
a device that requires an electrical current to operate; and,
a soil battery used to provide power to the device, the soil battery including:
anode material placed in soil, and
cathode material placed in the soil.

2. A system as in claim 1, wherein the device comprises a sensor in wireless communication with a monitoring system.

3. A system as in claim 2 wherein the sensor includes a moisture detector.

4. A system as in claim 2 wherein the sensor includes a thermometer.

5. A method for performing monitoring comprising:
placing a sensor in wireless communication with a monitoring system; and,
generating power for the sensor by placing anode material and cathode material within soil.

6. A method as in claim 5 wherein the sensor includes a detector that measures level of liquid within a storage container.

7. A method as in claim 5 wherein the sensor includes a moisture detector.

8. A method as in claim 5 wherein the sensor includes a thermometer.

9. A remote system that performs monitoring, comprising:
communications means for performing wireless communication with a monitoring system; and,
power means for receiving power from anode material and cathode material placed in soil.

10. A remote system as in claim 9 wherein the remote system additionally comprises a detector that measures level of liquid within a storage container.

11. A remote system as in claim 9 wherein the remote system additionally comprises a detector means for detecting moisture.

12. A remote system as in claim 9 wherein the remote system additionally comprises a detector means for detecting temperature.

13. A method for providing power to a device that requires an electrical current to operate, the method comprising:
placing anode material in soil;
placing cathode material in soil; and,
utilizing current flowing between the anode material and the cathode material to provide power to the device.
